(19) United States
(12) Patent Application Publication
(10) Pub. No.: US 2026/0056061 A1
(43) Pub. Date: Feb. 26, 2026

(54) Method and Apparatus for Analyzing and Propagating an Ultrafast Laser Beam

(71) Applicant: Mesa Photonics, LLC, Santa Fe, NM (US)

(72) Inventors: Daniel J Kane, Santa Fe, NM (US); Keith A Wernsing, Santa Fe, NM (US)

(21) Appl. No.: 19/303,972

(22) Filed: Aug. 19, 2025

Related U.S. Application Data
(60) Provisional application No. 63/685,227, filed on Aug. 20, 2024.

(51) Int. Cl. G01J 11/00

(52) U.S. Cl. CPC G01J 11/00

(57) ABSTRACT

A system provides a complete spatiotemporal representation (i.e., the spatially dependent electric field) of an ultrafast laser pulse at any point in an optical system. The ultrafast laser pulse is sampled from the system and provided to an apparatus that performs a spatially and spectrally resolved wavefront measurement and a temporal measurement near the center of the pulse. This measured spatiotemporal representation of the pulse is provided to a system that propagates the pulse through optical elements to provide a propagated spatiotemporal representation at a desired analysis position within the optical system. The spatiotemporal representation of the wavefront can be compressed and the propagation may apply a dyadic Green's function derived from the Helmholz equation.

### CROSS-REFERENCE TO RELATED APPLICATIONS

This application claims priority to U.S. provisional patent application Ser. No. 63/685,227, filed Aug. 20, 2024, which application is incorporated by reference in its entirety. invention.

### GOVERNMENT RIGHTS

This invention was made with government support under DE-SC0020702 awarded by the U.S. Department of Energy. The government has certain rights in the

### RELATED ART

Ultrafast laser pulses often exhibit spatiotemporal coupling in which the pulse electric field cannot be stated as a product of purely temporal and spatial factors. For example, an ultrafast laser pulse may exhibit spatiotemporal coupling in the form of chromatic aberrations, where the focal properties of the laser pulse vary with frequency over the pulse bandwidth. It can consequently be important to have a spatiotemporal characterization of the ultrafast laser pulse to understand or predict the interactions of the pulse. Jolly, et al., Spatio-Temporal Characterization of Ultrashort Laser Beams: A Tutorial, J. Opt. 22, 103501 (2020), includes a discussion of the nature of spatiotemporal coupling and the effects spatiotemporal coupling can have on laser pulses.

The most generalized approach to spatiotemporal characterization of a broadband field requires measuring the complete electric field as a function of spatial coordinates. That is, spatiotemporal characterization requires measuring \tilde{E}(x, y, ω)=\sqrt{S(x, y, ω)} exp (iφ(x, y, ω)), where S (x, y, ω) is the pulse spectrum as a function of space, and φ(x, y, ω) is the spectral phase as a function of space. It is not sufficient to measure the pulse spectral intensity and spectral phase at each spatial point (x,y) independently, using a self-referencing pulse measurement technique, such as frequency resolved optical gating (FROG), as this neglects the spatial phase behavior of each individual spectral component ω at across (x,y) space. Obtaining the 3-dimensional phase map φ(x, y, ω) is the key component of spatiotemporal coupling. It is this phase relationship that allows \tilde{E}(x, y, ω) to be transformed into other spaces, i.e., (x,y,t), (kₓ,k_{y},t), (kₓ,k_{y},ω), and it is this phase relationship that allows the pulse to be propagated and modeled through an optical system.

Known techniques can provide incomplete, but still practically useful information about the pulse such as angular dispersion, spatial chirp, and pulse front tilt. These techniques do not generally measure the full spatiotemporal pulse. Obtaining the spatially dependent relative phase variation can be done using spectral interferometry, Fourier transform techniques, digital holography, spectrally resolved spatial shearing interferometry, and spatially resolved spectral phase interferometry for direct electric-field reconstruction of ultrashort optical pulses (SPIDER). Dorrer, Spatiotemporal Metrology of Broadband Optical Pulses, IEEE J. Tops. in Quant. Elec. Vol. 25, no. 4, 3100216 (2019) provides an overview of techniques that can be used for characterization of an ultrafast laser pulse. Jolly, et al., Spatio-Temporal Characterization of Ultrashort Laser Beams: A Tutorial, J. Opt. 22, 103501 (2020), also discusses techniques that can be used for characterization of an ultrafast laser pulse.

Shack-Hartmann sensors are devices that can measure the wavefront shape and intensity distribution of incident beams. Commercially available Shack-Hartmann wavefront sensors include a two-dimensional microlens array that receives an incident beam and locally focuses portions of the beam onto a two-dimensional sensor array such as a camera. The microlens array creates a field of spots on the surface of the sensor array. The intensity and location of each spot is analyzed to measure the incident wavefront, for example, to characterize the wavefront distortion present in the beam or caused by optical components. One form of a Shack-Hartmann sensor is described in, for example, U.S. Pat. No. 5,936,720, entitled “Beam Characterization by Wavefront Sensor,” which issued Aug. 10, 1999. Shack-Hartmann sensors are commercially available from, for example, Thorlabs, Inc. of Newton, New Jersey.

Frequency-resolved optical gating (FROG) is an ultrafast laser diagnostic that can determine the intensity and phase of an ultrashort laser pulse. FROG measures the spectrum of a particular temporal component of an optical pulse by spectrally resolving the signal pulse in an autocorrelation-type measurement using an interaction within a nonlinear medium. The FROG system produces a spectrogram of an input pulse that is a three-dimensional plot of intensity versus frequency and time delay, showing the spectral variations of time slices of the pulse. An input pulse, or wave, is split into two identical pulses (waves) using a beam splitter. One of the pulses is delayed in time relative to the other and the two pulses are combined within a nonlinear medium that multiplies the two pulses together, so that one pulse gates a portion of the other pulse. The FROG system spectrally resolves the gated signal and records the spectrum as a function of relative time delay to form a spectrogram. U.S. Pat. No. 7,130,052 is entitled “Real-Time Measurement of Ultrashort Laser Pulses” and describes a frequency resolved optical gating (FROG) system and methods of using that system for the real time analysis of ultrafast laser pulses.

Cross-correlation FROG (X-FROG) uses a spectrally resolved cross-correlation between a known ultrafast laser pulse and an unknown ultrafast laser pulse to characterize the unknown pulse. There are several advantages to using a known pulse to characterize an unknown pulse. Wider wavelength ranges of ultrafast laser pulses can be measured; mid-infrared pulses can be mixed with different wavelength pulses to shift the measurement to inexpensive detectors. Complex, wide bandwidth ultrafast laser pulses, such as continua, can be characterized. Weak pulses can be measured by being cross correlated with higher power pulses. X-FROG can be viewed as a special case of the general FROG strategy, but some modifications are needed to take advantage of the information available about the known reference pulse. Like FROG, the extraction of the unknown pulse characteristics in X-FROG is usually accomplished using two-dimensional phase retrieval. U.S. Pat. No. 9,423,307 is entitled “Method and Apparatus for Determining Wave Characteristics Using Interaction with a Known Wave,” and describes an X-FROG system in which a known cross-reference input pulse is used to analyze an unknown ultrafast laser pulse. FROG and X-FROG systems are commercially available from Mesa Photonics, LLC of Santa Fe New Mexico.

Propagation simulation methods fall into roughly three different groups.

Unfortunately, no ultrafast pulse propagation method solves all the problems that need to be solved to accurately propagate pulses through arbitrary optical systems. The first simulation method is geometrical optics or ray tracing, which can use both single rays and ray packets-so called “fat rays” or “Gausslets.” These rays are propagated though the optical system in a rectilinear fashion without diffraction to obtain performance parameters such as aberrations. The second simulation method is scalar diffraction propagation, which is dominated by Fourier optics, including both Fresnel diffraction and angular spectrum propagation. The third simulation method is full vector propagation, which numerically obtains the full vector solution of the wave equation. This is the most general approach, but it is computationally intensive.

The “fat ray” approach decomposes an input source into a summation of small Gaussian beamlets. Individual ray bundles are propagated through the optical systems and coherently added to reconstruct the propagated beam. FRED Optical Engineering Software from Photon Engineering LLC is an example of commercial software that uses fat rays. While this method is quite good for determining system aberrations, it is not the best approach for including gain, nonlinear effects, or thermal effects into optical system analysis. Because of the soft roll-off of Gaussian beam profiles, it is also difficult to model fields at sharp apertures. The finite element approach with fat ray propagation has been attempted but has not reached wide use. Of course, individual rays can be used as well.

Scalar wave theory assumes that the light field can be approximated by a complex scalar potential and is valid for apertures and objects much larger than the light field wavelength λ. Scalar wave propagation assumes a linear superposition of monochromatic components. The strategy can be applied to most situations including modeling amplifiers and nonlinear optics (before beam break-up). Scalar wave propagation also can be used in split-step and finite element propagation to model amplification, nonlinear behavior, and thermal effects. Fresnel, Franhouffer, and angular spectrum approaches all assume scalar propagation. GLAD is an example of a commercial software package from Applied Optics Research that utilizes scalar diffraction propagation.

A major drawback of scalar diffraction theory is that it does not easily determine optical aberrations that occur in most practical optical systems. Optical aberrations cause wavefront error, which is described by an optical path difference (OPD) function that represents the difference between a perfect spherical wave and the aberrated wavefront surfaces. Often, aberrations are determined using a ray tracing package such as Zemax OpticStudio from Ansys, Inc. of Canonsburg Pennsylvania and converted into polynomial phase functions such as the Seidel polynomials. Aberrations are often space variant and so appropriate analysis must determine Seidel polynomials for different regions depending on the beam size and location.

### SUMMARY OF THE PREFERRED EMBODIMENTS

An aspect of a preferred embodiment provides a method of propagating a spatiotemporal representation of broadband light through an optical system, comprising receiving a spatiotemporal representation of the broadband light as a first wavefront data set. The method proceeds by compressing the first wavefront data set into a set of first compressed vectors and propagating the set of first compressed vectors through a first optical element to generate a set of second compressed vectors representative of the broadband light passing through the first optical element.

Another aspect of an embodiment provides a method of propagating a spatiotemporal representation of broadband light through an optical system by measuring a spatiotemporal representation of the broadband light to provide a first wavefront data set. The first wavefront data set is compressed into a set of first compressed vectors. The first set of compressed vectors is propagated through a first optical element to generate a set of second compressed vectors representative of the broadband light passing through the first optical element.

Still another aspect of an embodiment provides a method for characterizing broadband light within an optical system comprising sampling broadband light from within an optical system to extract a set of first slices from the broadband light. For each of the set of first slices, a wavefront of the broadband light is measured using a spatially and spectrally resolved wavefront detector to produce a first signal set. The broadband light is sampled again to extract at least one second slice from the broadband light, the second slice oriented differently from the first slices. For the at least one second slice, a wavefront of the broadband light is measured using a spatially and spectrally resolved wavefront detector to produce a second signal set. The broadband light is sampled again to extract an optical signal from a central portion of the broadband light and measured to produce a spectrally and temporally resolved third signal set. The first, second, and third signal sets are processed to provide a measured spatiotemporal representation of the broadband light. The method proceeds by propagating the measured spatiotemporal representation to a second position within the optical system to provide a propagated spatiotemporal representation at the second position.

In a particular implementation of this aspect, the measured spatiotemporal representation is compressed into a set of first compressed vectors. The set of first compressed vectors is propagated through a first optical element to generate a set of second compressed vectors representative of the broadband light passing through the first optical element.

### BRIEF DESCRIPTION OF DRAWINGS

The accompanying drawings illustrate aspects of the described embodiments and are incorporated into and form a part of this disclosure. The drawings are illustrative and are not to be construed as limiting.

FIG. 1 is a schematic illustration of an apparatus providing spatiotemporal characterization of an ultrafast laser pulse.

FIG. 2 illustrates a template that provides entrances to different components of a spatiotemporal analysis system.

FIG. 3 compares measured versus dyadic Green's function propagated performance for coupling light into a fiber optic.

FIG. 4 shows the impact of diffraction on the dyadic Green's function propagation of an ultrafast laser pulse following interaction with a hard edge.

### DETAILED DESCRIPTION OF THE PREFERRED EMBODIMENTS

Broadband optical fields often have or can acquire spatially nonuniform temporal or spectral properties. Passing a broadband pulse through simple optics can profoundly change the pulse. For example, a wavefront passing through a wedge made from optical quality glass experiences different levels of dispersion because the glass introduces dispersion corresponding to the increasing thickness of the glass across the wedge. Passing through such a wedge creates pulse wavefront tilt. Pulse wavefront tilt Fourier transforms into spatial chirp (spatial wavelength variations across the pulse front) since the pulse tilt causes different wavelength light to propagate in different directions. This is a form of spatiotemporal coupling.

Another type of spatiotemporal coupling might be generated by a pulse wavefront passing through a lens. Merely passing through a simple lens can introduce pulse wavefront curvature due to the different thicknesses of dispersive glass (or other material). More substantial pulse wavefront curvature can be introduced by passing the pulse through a pair of lenses having chromatic aberrations, such as might be used in a 4f relay. Such lenses may be near ideal for a specified wavelength, but do not provide ideal performance for a broadband light source. Transmitting the pulse wavefront through such a lens pair introduces pulse wavefront curvature. Many demanding applications require precise knowledge of either the spatial or temporal profile of a light pulse. In a few situations decoupled information from either domain is sufficient. For example, determining the temporal profile of the pulse would be sufficient if only compensation of the dispersion of a window is needed. On the other hand, when the shape of the pulse changes between spatial positions, such as when propagating a pulse through optics with chromatic aberrations, determining the temporal profile and spatial profile separately is inadequate and often leads to erroneous results. Precise beam propagation requires full spatiotemporal characterization.

Developing a spatiotemporal representation of an ultrafast laser pulse throughout an entire ultrafast system requires that the complete spatially dependent electric field (here, the spatiotemporal representation) of the pulse be known at any point in the system. Determining just the temporal profile of the pulse is insufficient for many applications. It is also insufficient to determine only the spatial intensity profile of the pulse together with the temporal profile of the pulse. As discussed below, it is possible to measure the spatiotemporal representation of a pulse by sampling the pulse at a position within the target optical system. On the other hand, obtaining such a spatiotemporal representation at a single position may be inadequate for many purposes. It is typically not possible to sample and measure the pulse at any arbitrary position within the target optical system. It is accordingly useful to propagate through simulation a measured or otherwise characterized pulse from one position to a different, target position within an optical system, determining the spatiotemporal representation of the pulse at that target position and any other desired position.

An especially preferred system or method is adapted to provide a complete spatiotemporal representation (i.e., the spatially dependent electric field) of an ultrafast laser pulse at any point in an optical system. As part of this, a preferred system or method may determine the spatiotemporal representation by performing desired measurements of the ultrafast laser pulse at a sampling position within the optical system. Another aspect propagates a known, measured or otherwise, spatiotemporal representation of an ultrafast laser pulse to other positions within the optical system. Measurement of the ultrafast laser pulse may begin, for example, by sampling the ultrafast laser pulse from the system and providing the pulse to an apparatus or method that performs a spatially and spectrally resolved wavefront measurement and a temporal measurement near the center of the pulse. The resulting measured spatiotemporal representation of the pulse may preferably then be provided to a propagation system or method that propagates the pulse through optical elements to provide a propagated spatiotemporal representation at a desired position within the optical system.

The spatiotemporal representation of the wavefront preferably is compressed, for example using a singular value decomposition and vector selection strategy, preferably as an initial stage of propagation. Compressing the spatiotemporal representation prior to propagating the spatiotemporal representation, as presently preferred, reduces the complexity of the propagation and facilitates the propagation. As a practical matter, the compression preferably is performed on the spatially varying (laterally, e.g., in x and/or y) portions of the spatiotemporal representation, which is generally the spatially resolved wavefront representation. Often propagation is not practical without compression. The propagation may move forward through the optical path or could be accomplished in reverse to provide a spatiotemporal representation at a point in the optical path prior to the sampling point.

An implementation of an illustrative system provides a capability of measuring the spatially dependent electric field of an ultrafast laser pulse at a position within an ultrafast optical system. For example, such an implementation may perform a spatially and wavelength resolved wavefront measurement and a temporal measurement of the laser pulse, for example near the pulse center, that combined with the wavefront measurement provides a complete spatiotemporal representation of the ultrafast laser pulse at the measurement position. The wavelength resolved wavefront measurement system may include, for example, a pair of complementary spectrally resolved imaging detectors and a single temporal measurement at the beam center to provide the axial phase relationships between the individually measured spectral wavefronts.

An ultrafast laser pulse (or an ultrashort pulse) is generally one that has a duration of less than 10 picoseconds. The ultrafast lasers discussed here generate generally indistinguishable pulses at a high rate. Aspects of measuring such pulses may sample or average over many individual pulse occurrences, producing a measurement representative of each of the pulses in the stream of pulses. In other instances, a measurement system may characterize a wavefront at least in part from a single pulse. Also, while the specific implementations here are described in terms of ultrafast optical systems, aspects of the preferred physical measurement system and aspects of the compressed propagation system and method discussed here can be used for analysis of more conventional optical systems. For example, ultrafast laser pulses are typically broadband; the propagation strategies and methods described here can also be applied to other broadband light systems.

As one particular example of the physical measurement aspect of this process, the wavefront measurement may use two Shack-Hartmann sensors embedded within respective imaging spectrometers. A vertical slit is positioned in the path of the pulse entering a first imaging spectrometer and that vertical slit is scanned across the horizontal width of the pulse so that the first embedded Shack-Hartmann sensor collects a set of spectrally resolved, vertically extending wavefront slices. Of course, the vertical slit may be held stationary and the beam scanned horizontally over the slit. A horizontal slit is positioned in the path of the pulse before the second imaging spectrometer and that slit allows the second embedded Shack-Hartmann sensor to collect a spectrally resolved, horizontally extending measurement that ties together the vertically sampled spectrally resolved wavefront slices into a full two-dimensional wavefront. Finally, a temporal measurement is made at the beam center, for example using a frequency resolved optical gating (FROG) device, to complete the information necessary for a spatiotemporal representation of the ultrafast laser pulse.

Preferably, the measurement system incorporates a template with three appropriate apertures in a single plane so that the set of apertures provides a common entrance plane to the three measurement subsystems.

Another aspect of a preferred implementation provides a capability of determining the spatially dependent electric field of a previously characterized ultrafast laser pulse at an earlier or later position in an ultrafast laser pulse optical system by propagating the electric field characteristics through the optical elements of the ultrafast laser pulse optical system. In this way, the spatiotemporal representation of the ultrafast laser pulse can be obtained at a position that is not convenient for measurement using the spatiotemporal representation obtained at another, more convenient measurement position. The propagation may, for example, apply a dyadic Green's function derived from the Helmholz equation for each homogeneous optical element within the optical system. Most preferably, a discrete version of the spatiotemporal representation is compressed before applying the dyadic Green's function propagator.

A pulse's spatiotemporally distributed electric field is written generally as E (x,y,z,t)=A (x,y,z,t) exp [i φ(x,y,z,t)] where A is the field amplitude, and φ is the field phase. The electric field is a real-valued quantity but is customarily written in complex form where it is understood that the real part is to be taken. To make a complete measurement of E at a location z, where z defines a transverse plane orthogonal to the propagation axis of the pulsed beam, six quantities must be determined: the magnitude A and the phase φ, each measured in two spatial dimensions, x and y, and one temporal dimension, t. Equivalently, measurements across x, y and t can be made in their conjugate domains-kₓ, k_{y}, and ω, respectively—and Fourier transformed.

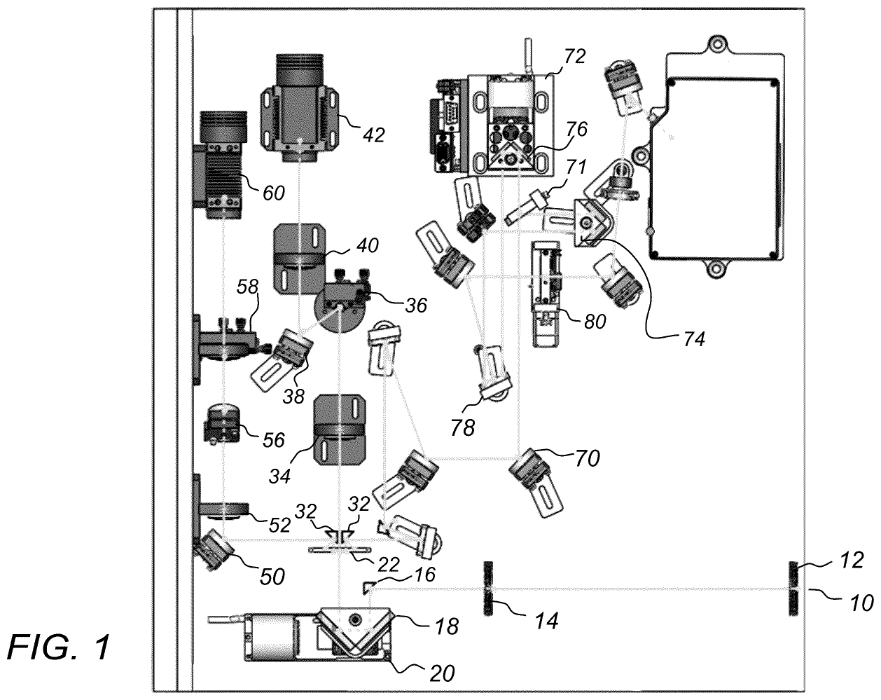

FIG. 1 schematically illustrates aspects of a spatiotemporal pulse measurement system, which preferably includes two Shack-Hartmann sensors each embedded within one of two corresponding imaging spectrometers. Ignoring for simplicity various optical details, discussed below, each of the embedded Shack-Hartmann sensors includes in optical order a slit, a lens in the 2f configuration, a grating, another lens in the 2f configuration, and the Shack-Hartmann sensor. Together, the two lenses form a 4f imaging system, with the grating situated at the so-called ‘Fourier plane’ of the 4f imaging system. Ideally, an angle imparted in the Fourier plane is mapped to a unique position in the image plane. The input ultrafast laser pulse train is incident on one of the slits and the slit selects a spatially narrow slice from the two-dimensional cross section of the pulsed beam. This slice is effectively spatially Fourier-transformed by the first lens and made incident on the grating, which imparts a unique angle to each spectral component (e.g., each wavelength) present in the original slice. This set of unique wavelength-dependent angles is provided to the second lens, which performs a second Fourier transform and produces at the microlens array a set of images of the entrance light at the slit, separated in space according to wavelength. The Shack-Harmann sensor then determines the 1-dimensional wavefront shape for the various spectral components of that slice of the pulse. The data generated by this measurement are recorded. Taking the vertical slit/Shack-Hartmann sensor portion of the FIG. 1 system as the example, the system changes the relative position of the slit with respect to the pulse to extract another slice from the pulse. As discussed below, the pulse is preferably moved with respect to the slit, for example using a roof mirror, but the slit could instead be moved with respect to the pulse. The expansion, imaging, Shack-Hartmann measurement, and data collection are repeated for the next, preferably adjacent, slice and for each of the other slices that make up the pulse to iteratively measure the entire two-dimensional cross-section of the pulse.

The result of this vertical slit/Shack-Hartman measurement process is a spectrally resolved mapping of the vertical wavefront that lacks complete (i.e., horizontal) phase information between the slice components and that also lacks time information. To address the incomplete phase information in the data set, the system further measures a horizontal slice through the pulse. That is, the system directs the input ultrafast laser pulse train onto a horizontal slit to extract a spatially narrow horizontally extending slice from the pulse. The system directs the horizontal slice to a second grating via the first lens, the grating spectrally expands the slice, and the second lens provides the spectral components of the pulse slice to different portions of the imaging microlens array entrance to the associated horizontal Shack-Hartmann sensor. The Shack-Harmann sensor then determines the wavefront shape for the various spectral components of the horizontal slice of the pulse. The data generated by this spectrally resolved horizontal slice measurement are recorded. Preferably, for both of the Shack-Hartmann-based measurements, the measurement or sampling position is selected to be away from a focus of the optical system to better utilize the resolution of the Shack-Hartmann sensors.

Finally, the pulse is positioned to be coupled through an aperture in the preferred template to a frequency resolved optical gating (FROG) apparatus that measures the temporal delay of the wavefront crest for each frequency relative to a central frequency @0. Positioning of the horizontal wavefront slice, the vertical wavefront slices, and the FROG aperture preferably is precisely known so that the various measurements can be precisely matched to the other measurements. The terms horizontal and vertical here describe a convenient configuration, but the imaging spectrometers and sensors can be arranged differently so long as the two imaging spectrometers and sensors provide a complete data set for the amplitude and phase of the ultrafast laser pulse wavefront. Preferably, the measurement system incorporates a template with three appropriate apertures in a single plane: a vertical slit; a horizontal slit; and a point-like aperture for the FROG or other temporal measurement, where the apertures in the template provide a common entrance plane to the three measurement subsystems. The FIG. 1 apparatus is now described in greater detail.

The pulse 10 to be measured enters the FIG. 1 apparatus at the lower right-hand side of the apparatus and passes through first and second input irises 12, 14. The pulse 10 is incident on a mirror 16 that directs the pulse to a retroreflecting hollow roof mirror 18. Retroreflecting hollow roof mirrors are commercially available. The roof mirror 18 is presently preferred as it is comparatively light weight, allowing fast movement and settling of pulse positioning operations. Mirror 16 preferably directs the pulse 10 in a plane perpendicular to the line where the two flat mirror components of the roof mirror 18 meet. Preferably the roof mirror 18 is mounted on a translation stage 20 that may, for example, be driven under computer control by a voice coil motor or by a stepper motor and preferably travels in a line parallel to the direction of the pulse through the irises 12, 14. Movement of the translation stage 20 scans the pulse 10 across the input plane of the template that defines the entrance to the three measurement assemblies within the FIG. 1 apparatus.

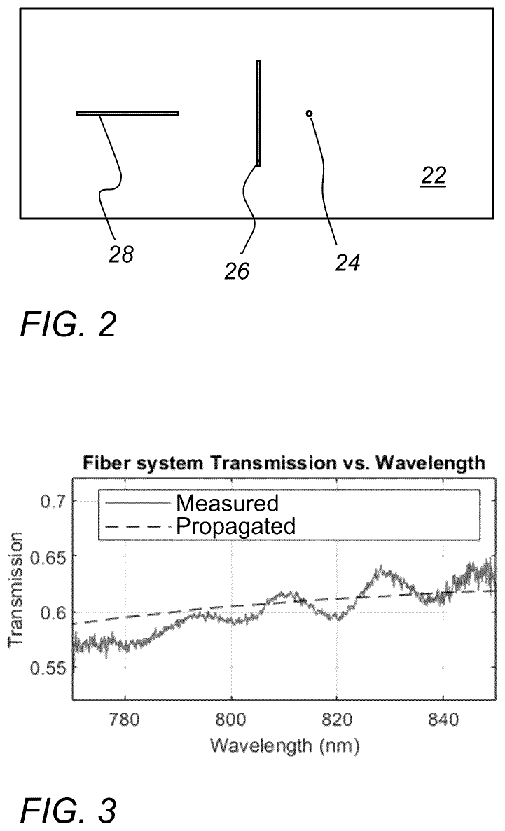

The input plane of the FIG. 1 system holds a template 22 such as that illustrated in FIG. 2. The FIG. 2 template 22 provides three apertures corresponding to the three measurement assemblies of FIG. 1. The template 22 defines the entrance to each of the measurement assemblies and facilitates the registration of the outputs of the three measurements. On the right of template 22 is a circular aperture 24 that establishes the image point for a temporal pulse measurement such as that performed by a frequency resolved optical gating (FROG) device. The aperture may be, for example, a 500 micron diameter circular pinhole. The translation stage 20 can be moved under computer control to position the pulse 10 at the aperture 24 so that the FROG or other temporal measurement such as X-FROG or SPIDER captures the central portion of the pulse. In the center of template 22 is a vertical slit 26 that captures a vertical slice of the pulse at each position defined by the translation stage 20 as the translation stage 20 moves the pulse across the slit 26. The vertical slit 26 may be, for example, approximately 100 microns across. Each of the vertical slices is provided to a first wavefront imaging spectrometer, which makes vertical spatial and spectral wavefront measurements. On the left of the template 22 is a horizontal slit 28, which samples a horizontal slice through the pulse 10 when the translation stage 20 positions the pulse at the left horizontal slit 28 of the template 22. The horizontal slit 28 may be, for example, approximately 100 microns across.

When the translation stage 20 positions the pulse 10 at the central vertical slit aperture 26 of the template, the vertical slice passes through the aperture defined by mirrors 30, 32 and is incident on lens 34, which focuses the vertical slice onto a grating 36 that spectrally resolves (i.e., expands in frequency) the light in the vertical slice and directs it to mirror 38. A second lens 40 collects and passes the spectrally resolved vertical slice through to the Shack-Hartmann sensor 42, which measures the A (y) and φ(y) for each optical frequency ω, and the system records the A (y) and φ(y) for each optical frequency ω. The translation stage 20 then moves the pulse to a new position and another vertical slice is captured at another horizontal (x) position, and lens 34 focuses that vertical slice on grating 36, which similarly spectrally disperses that vertical slice, which passes to the second lens 40. Second lens 40 collects that spectrally resolved vertical slice and passes it to the Shack-Hartmann sensor 42 to measure and record the vertical A (y) and φ(y) for each w. This process of moving the pulse across the vertical slit 26 is repeated until the horizontal extent of the pulse is measured. After the entire pulse has been translated across the vertical slit, the amplitude measurement A (x,y,ω) is complete.

In the first imaging spectrometer assembly, lenses 34 and 40 form a 4f image relay. The grating 36 is positioned, for example, at the Fourier plane defined by the focal lengths of the lenses 34, 40; flat mirror 38 folds and laterally moves the beam path and does not alter the dimensions of the 4f relay. As is known in the art, the lenses 34, 40 can have different focal lengths, but in the FIG. 1 implementation the focal lengths preferably are taken to be the same. Thus, the grating 36 preferably is separated from each of the lenses by their common focal length. The 4f image relay is particularly useful here because it preserves the fidelity and phase of the vertical slice; that is, the 4f image relay reproduces both the spatial intensity (the observable image) and the spatial phase of the vertical slice.

The translation stage 20 also positions the pulse to pass through the horizontal slit 28 of the template 22. The horizontal slice of the pulse is directed to mirror 30 and then to mirror 50, which directs the horizontal slice into the second wavefront imaging spectrometer mounted vertically on the side of the FIG. 1 apparatus. All of the elements described above for the first wavefront imaging spectrometer are present in the second wavefront imaging spectrometer, but because they are positioned vertically, not all of the elements are shown in FIG. 1. The horizontal slice from mirror 50 passes through a lens 56, which focuses the horizontal slice onto a grating (not shown here) that spectrally resolves (i.e., expands in frequency) the light in the horizontal slice and directs it to mirror 56. The spectrally resolved horizontal slice passes through a second lens 58 to the Shack-Hartmann sensor 60, which measures the A (x) and φ(x) for each optical frequency ω at one vertical position horizontally across the pulse. The system then records the A (x) and φ(x) for each optical frequency ω. Both the grating (not shown) and the Shack-Hartmann sensor 60 are rotated by ninety degrees from their arrangement in the first wavefront imaging spectrometer. Lenses 52, 58 and the grating (not shown) are arranged to form a 4f image relay functioning similarly to that discussed above for the first wavefront imaging spectrometer.

As the beam is scanned across the vertical slit, each vertical slice is spectrally dispersed by a grating and then imaged onto a Shack-Hartmann wavefront sensor, recording A (y) and φ(y) for each optical frequency ω. After the entire beam has been translated across the vertical slit, the amplitude measurement A (x,y,ω) is complete. However, the phase is only known in y for each slice. For example, if a divergent wavefront has been measured for each vertical slice, it is unknown whether the beam is cylindrically divergent in y only, or spherically divergent in both x and y. To determine the horizontal wavefront curvature, a separate phase measurement is needed across x to tie all the vertical wavefront slices together. This job is performed by the second wavefront imaging spectrometer behind the horizontal slit. The horizontal wavefront measurement only needs to be performed at one known y-position of the beam, and therefore there is no need to translate the beam vertically across the aperture plane. Finally, a FROG measurement is made through the pinhole aperture 24, which provides the temporal delay of the wavefront crest for each frequency ω in the pulse, relative to the center frequency ω₀. The precise machining of the aperture screen allows the pinhole FROG measurement to be matched to the corresponding vertical wavefront slice; the same principle follows for matching the horizontal wavefront measurement to the set of vertical slices.

When the translation stage positions the pulse 10 to be incident on the circular aperture 24, the aperture images a central portion of the pulse into a temporal pulse measurement system such as a self-referencing FROG device. The small circular aperture is needed to register the spectral phase at a single spatial position of the beam.

Light passing through the template 22 via the aperture 24 is directed into the exemplary FROG device by the flat mirror 32, which directs the pulse sample off a pair of curved mirrors that serve to magnify or expand the beam. Expansion of the pulse is useful to the operation of the beam splitter. The expanded beam then reflects off flat mirrors including steering mirror 70, which directs the pulse to a beam splitter 71. Beam splitter 71 is a shearing beam splitter including D-mirror 71 that picks off part of the incident beam and passes the remaining beam part to mirror 76 on translation stage 72. The D-mirror 71 reflects a second part of the beam to roof mirror 74, which directs the reflected part portion of the pulse off another flat mirror to a focusing mirror 78, which directs the part of the pulse off another flat mirror to the nonlinear medium 80. The portion of the pulse that passes to the translation stage 72 reflects off roof mirror 76, effectively delaying this portion of the pulse with respect to the other portion of the pulse. The delayed pulse portion travels from the roof mirror 76 to a focusing mirror 78, which directs the delayed portion of the pulse to overlap with the undelayed pulse portion at the nonlinear medium 80.

The two portions of the pulse overlap within the nonlinear medium 80 and interact to form a FROG signal. The FROG signal is directed by another mirror to a lens 82, which focuses the FROG signal onto the entrance slit of an imaging spectrometer. The FROG system produces a spectrogram of an input pulse, which is a three-dimensional plot of intensity versus frequency and time delay, showing the spectral variations of time slices of the pulse. Further information about the FROG device, its operation, its output signal, and the analysis used to extract the phase from the FROG spectrogram can be found in U.S. Pat. No. 8,068,230, entitled “Real-Time Measurement of Ultrashort Laser Pulses, issued Nov. 29, 2011, which patent is incorporated by reference in its entirety. Two-dimensional phase retrieval on the FROG spectrogram yields the phase of the ultrafast laser pulse.

A reference plane located upstream within the wavefront measurement device is imaged to both the Shack-Hartmann sensor 42 and the FROG input. In a calibration step, a pinhole is placed in the reference plane and precisely registers the FROG measurement to one spatial point on the Shack-Hartmann sensor. With this calibration (which only needs to be performed once), the spectral phase measured by the FROG can be applied to one spatial position in the stack of frequency dependent complex beam measurements retrieved from the Shack-Hartmann sensor. This procedure matches the spectrally dependent wavefronts calculated by the Shack-Hartmann sensor together allowing the compilation of the full pulse electric field.

The FROG measurement performed by the FIG. 1 apparatus can exhibit some problems because the pulse power is reduced by passing through the aperture 24 and because FROG generally requires higher pulse power to provide the nonlinear interactions that generate its output signal. It may then be desirable to use other information about the pulse, for example derived from the imaging wavefront sensors, to improve the phase retrieval from the FROG signal. For example, the strategy described in U.S. Pat. No. 10,274,378, entitled “Method and Apparatus for Determining Wave Characteristics Using Constrained Interactions of Waves,” issued Apr. 30, 2019, which patent is incorporated by reference in its entirety, could be used to improve the phase retrieval. Use of a self-referencing measurement such as FROG is preferred for at least some implementations because of the measurement's comparative simplicity.

Alternately, the FROG measurement could be replaced by a cross-correlation measurement such as a cross-correlation frequency resolved optical gating (X-FROG) measurement, which is well suited to analyzing weak input signals. Information about X-FROG can be found, for example, in U.S. Pat. No. 9,423,307 entitled “Method and Apparatus for Determining Wave Characteristics Using Interaction with a Known Wave,” which describes an X-FROG system in which a known cross-reference input pulse is used to analyze an unknown laser pulse, which may be an ultrafast laser pulse. The '307 patent is hereby incorporated by reference in its entirety. Use of the FROG, X-FROG, spectral phase interferometry for direct electric-field reconstruction of ultrashort optical pulses (SPIDER), or similar devices allows the FIG. 1 system to characterize the phase and temporal behavior of ultrafast laser pulses to provide a complete spatiotemporal representation of such an ultrafast laser pulse.

Shack-Hartmann sensors are useful for the FIG. 1 system because they are adapted to characterize or measure the wavefront of an incident pulse in a single operation. They also have the advantage of being a direct measurement that does not require a reference beam. A typical Shack-Hartmann sensor includes a microlens array matched with a two-dimensional detector array. The pulse wavefront is incident on the microlens array, which focuses different portions of the incident pulse onto the detector array. The curvature of the individual lenslet surfaces of the microlens array interacts with the wavefront to alter the focus of the incident portions of the incident pulse in a manner detected by the detector array. U.S. Pat. No. 5,936,720, entitled “Beam Characterization by Wavefront Sensor” and issued Aug. 10, 1999, describes the structure and construction of Shack-Hartmann sensors and the data analysis used to extract the wavefront amplitude and phase information across the pulse. U.S. Pat. No. 5,936,720 is hereby incorporated by reference in its entirety. The wavefront sensors described in U.S. Pat. No. 5,936,720 integrate over the frequencies or wavelengths of the incident wavefront. In contrast, the Shack-Hartmann sensors described with respect to the FIG. 1 illustration preferably are positioned within a modified optical arrangement that spectrally expands spatial slices of the incident pulse. Thus the preferred FIG. 1 vertical Shack-Hartmann sensor 42 provides phase and frequency information as a function of vertical position within a vertically extending slice of the incident pulse. Vertical Shack-Hartmann sensor 42 is preferably operated in a stepped, repetitive manner (for example, using the roof mirror 18 and translation stage 20) to sample vertical slices across the entirety of the pulse wavefront. While the Shack-Hartmann sensor is particularly preferred in the FIG. 1 implementation, as the Shack-Hartmann sensor makes comparatively direct measurements of the pulse wavefront and is readily integrated in the FIG. 1 system, another wavefront sensor might be implemented for one or both of the FIG. 1 Shack-Hartmann sensors.

Goldberger, et al., Single-Pulse, Reference-Free, Spatiospectral Measurement of Ultrashort Pulse-Beams, Optica vol. 9, no. 8, 894-902 (2022), which is incorporated by reference herein in its entirety, describes a ptychography based measurement of the spatial and spectral character of an ultrafast laser pulse. The ptychography system of the Goldberger article does not measure the temporal character of the measured pulse. Dorrer, Spatiotemporal Metrology of Broadband Optical Pulses, IEEE J. Tops. in Quant. Elec. Vol. 25, no. 4, 3100216 (2019) provides an overview of techniques that can be used for characterization of aspects of an ultrafast laser pulse. Jolly, et al., Spatio-Temporal Characterization of Ultrashort Laser Beams: A Tutorial, J. Opt. 22, 103501 (2020), also describes techniques for the partial spatiotemporal or spatiospectral characterization of an ultrafast laser pulse.

The resulting measurements of the three components of the FIG. 1 wavefront characterization system provide a complete description of the pulse's electric field and is a spatiotemporal representation of the pulse at whatever position the pulse was sampled.

In a further aspect of some preferred implementations, the spatiotemporal representation of the pulse within an optical system obtained by the FIG. 1 measurement system, or a similar complete spatiotemporal representation including for example a theoretical representation, preferably is propagated to another position within the optical system using a method, system, or model of ultrafast pulse propagation. The propagation method or system discussed here can be used either with a sampled and measured spatiotemporal representation or it can be used with a theoretical, generated spatiotemporal representation.

Propagating an electric field through an optical system begins with the well-known Helmholz equation for monochromatic field propagation in a homogeneous material. This equation describes the spatially dependent electric field of each wavelength of the laser pulse propagating within a homogeneous medium. One version of the Helmholz equation is the second order differential equation:

$$( {∇}^{2} + {k}^{2} ) U ( r - {r}^{′} ) = - δ ( r - {r}^{′} ) \qquad ( 1 )$$

which is here driven by a point-like source term. One solution to this Helmholz equation is given by:

$$U ( R ) = \frac{{e}^{- i k R}}{4 π R} \qquad ( 2 )$$

where R=r-r′. This solution allows the determination of the field anywhere in space. Because U (R) is the Helmholz equation solution when the Dirac delta function is the forcing function, U (R) is the Green's function solution of equation 1. Superposition of the Green's functions from a distribution of source points yields the total radiated field. Convolving the Green's function with a larger source distribution facilitates modeling a more complicated propagated field. This is, however, only a scalar solution. It can only provide the amplitude and phase behavior of radiated waves emanating from the source(s). It contains no information about the polarization of the radiated fields, which is why the vector solution, referred to as the dyadic Green's function, is needed for comprehensive modeling of optical systems and amplifiers.

The dyadic Green's function for electric field propagation is given by:

$$G ( R ) = i ω μ \frac{{e}^{- i k R}}{4 π R} [ ( \hat{1} - \hat{R} \hat{R} ) ( 1 - \frac{1}{{k}^{2} {R}^{2}} - i \frac{1}{k R} ) + \hat{R} \hat{R} ( \frac{2}{{k}^{2} {R}^{2}} + i \frac{2}{k R} ) ] \qquad ( 3 )$$

where \hat{R}\hat{R} is the dyad and is given by:

$$\hat{R} \hat{R} = [ \begin{matrix}{R}_{ux}^{2} & {R}_{ux} {R}_{u y} & {R}_{ux} {R}_{u z} \\ {R}_{u y} {R}_{u z} & {R}_{u y}^{2} & {R}_{u y} {R}_{u z} \\ {R}_{u z} {R}_{ux} & {R}_{u z} {R}_{u y} & {R}_{u z}^{2}\end{matrix} ] . \qquad ( 4 )$$

Rᵤₓ=(x-x′)/R, R_{uy}=(y-y′)/R, and R_{uz}=(z-z′)/R are the rectangular components of \hat{R}. R is the distance in the propagation direction.

The model here assumes that the propagation is in isotropic media (this is reflected in the Eq. 1 formulation of the Helmholz equation). Therefore, the model propagates the field from the source to each subsequent bounding surface along the optical path. For example, if the model pulse propagates from a source to a focus through a lens, the model first propagates from the source to the first surface of the lens. Because air has an index of 1, the k vector is simply 2π/λ. At the lens, the index changes and the higher index of refraction of the lens material (glass) decreases the wavelength of the propagating light. Another application of the propagator propagates the field from the incident surface of the lens to the exit surface of the lens. From the exit surface, a third propagation takes the field from the exit surface to the focal plane of interest. This approach is a reasonable approximation but it does not consider Fresnel reflections or losses. Adding these Fresnel reflection and/or losses can be useful in some circumstances and is a straightforward modification of the model. Three regions are defined for radiation calculations, based on the distance to the next surface along the optical path:
1. The reactive near field, which occurs at close range (R<2π/λ);
2. The radiative near field (2π/λ<R<2D²/λ), where D is the diameter of the pupil; and 3. The radiative far field (R >2D²/λ).
   λ is the wavelength of the monochromatic section of the pulse under consideration.

In the reactive near field, the complete dyadic Green's function (Eq. 3) preferably is used since the 1/R³ terms are significant. In the radiative near field, the 1/R³ terms preferably are ignored to reduce the computation time. For far-field calculations, the model preferably ignores both of the 1/R³ and 1/R² terms. For the simple example of a single lens, all the terms can be used to simplify the computational logic since most of the propagation within the lens falls into the second region (the radiative near field). The Green's function propagator has the advantage that lens behavior can be accurately predicted simply from knowledge of published lens parameters.

Ultrafast pulse propagation is accomplished by breaking the modeled pulse into spectral components in a manner identical to Fourier decomposition. Individual wavelengths or spectral components are then propagated through the optical system as monochromatic fields and reconstructed into a pulse when needed. For intensity dependent modeling, a split-step approach preferably is used to model nonlinear effects with the reconstructed pulse in the time domain, followed by standard linear propagation of the spectral components over short distances (a.k.a., finite element), before reconstructing the intensity again at a new location, z+dz.

To propagate the wavefront using the dyadic Green's function propagator, the wavefront is divided into a set of positions (e.g., a grid) across the x and y-axes. The spacing between these positions preferably is selected to be on the order of, but generally less than, the wavelength of the light being propagated. The array of wavefront positions is propagated using the dyadic Green's function from the input surface to a matching set of wavefront positions on the exit surface of the optical material (such as glass or free space). Each position on the input surface is propagated to every position on the exit surface. For structures of limited extent, such as an optical fiber or a fiber amplifier, this is a manageable data set and set of propagations. For more macroscopic structures, such as a lens which might be one inch in diameter, this may be a cumbersome and time-consuming operation, since the two-dimensional grid could include over 10⁹ points on each surface, with each of the 10⁹ or more points on a first surface propagated to each of the 10⁹ or more points on a second surface. For either a limited extent structure or a more macroscope sort of structure, the dyadic Green's function propagator can be very effectively implemented in parallel processing, whether on CPU cores or GPUs.

Note that the terms input surface and exit surface are used for clarity. These terms generally align with predicting the wavefront of a pulse further along a pulse propagation direction in an optical system following a sampling position or other position where the complete spatiotemporal representation of a pulse is available. As is evident from the equations set out above, it is possible to propagate the pulse in the opposite direction to determine the wavefront of the pulse prior to the sampling point or such other point where the complete spatiotemporal representation of a pulse is available.

When the dimension of the optical structure being modeled is such that the full wavefront description at the preferred grid density (x and y point spacing generally less than the wavelength) has too many points, the dyadic Green's function propagation becomes impractical. Most preferably, in at least those cases where the optical structure is comparatively large, particularly preferred implementations of the dyadic Green's function propagator further process the input spatiotemporal representation of the wavefront before applying the propagator. In particular, this preferred implementation preferably proceeds by compressing the wavefront representation. For example, a wavefront having the general form of f (x,y) is rewritten as g (x) h (y). f (x,y) might be, for example, a complete spatiotemporal representation of the pulse wavefront obtained by sampling from the optical path and measuring the pulse with an apparatus like that illustrated in FIG. 1. Alternately, the complete spatiotemporal representation may be a theoretically determined pulse wavefront. Generating g (x) h (y) from a complete spatiotemporal representation f (x,y) may be accomplished, for example, by performing a singular value decomposition on the wavefront representation f (x,y), which rewrites the f (x,y) matrix as the product of three other matrices, with useful properties discussed below. In this case, g (x) and h (y) can be propagated independently as 1-D propagations and then multiplied together via outer product after the complete or a partial propagation, as desired.

The preferred compression strategy is generally applicable because it uses the singular value decomposition (SVD) to compress the wavefront into a few outer products. A singular value decomposition or SVD yields:

$$[ U , S , V ] = s v d ( f ( x , y ) ) \qquad ( 5 )$$

$$where$$

$$f ( x , y ) = U \cdot S \cdot {V}^{*} . \qquad ( 6 )$$

Here, the columns of matrix U are the y vectors (left singular vectors), the columns of matrix V are the conjugate transpose of the x vectors (right singular vectors), and the diagonal elements of matrix S represent the weights. Keeping only the N vectors with the highest weights gives the best rank N representation of the wavefront in the least squares sense. N can be selected in part to make the propagation practical. N can also be selected to achieve a desired level of accuracy in the propagation.

As one illustrative example, a Gaussian wavefront can be fully represented by a single outer product pair. Hence, Gaussian beams can be fully propagated through a linear optical system by two 1-D vector propagations. The propagation is performed by propagating each of the x-positions in the x-vector on the input surface to each of the x-positions in the x-vector on the exit surface, for example, using equation 3. Similarly, each of the y-positions in the y-vector on the input surface is propagated to each of the y-positions in the y-vector on the exit surface for example using equation 3. This provides two 1-D vectors on the exit surface that represent the wavefront on the exit surface. Further propagations using these two propagated vectors can be performed to propagate through the desired optical system. After the final propagation, the outer product of the two propagated 1-D vectors is taken to provide the propagated wavefront at the exit surface of the modeled structure (e.g., the lens exit surface or the optical system exit surface). Ideal Gaussian pulses are comparatively simply propagated; lightly distorted Gaussians can be propagated using only a few vector pairs.

Differing levels of compression may be used as appropriate. Generally the SVD with selection of N vector pairs is an effective compression scheme in common optical systems. If the temporal component is measured as described with respect to FIG. 1, the temporal component does not vary in the lateral (e.g., x and y) directions. The meaningful components for compression generally are from the spatially resolved wavefront measurements (i.e., amplitude and phase).

Processing of the spatiotemporal representation begins by decomposing the spatiotemporal representation into monochromatic components, which preferably are individually processed through the subsequent propagation. The decomposition might alternately be performed after the propagator compresses the wavefront. The propagator preferably applies a singular value decomposition (SVD) or other form of compression to the preferred monochromatic representation of the wavefront at the input surface of an optical element that can reasonably be modeled as a homogeneous medium. The propagator selects N vector pairs from the SVD matrices as a compressed spatiotemporal representation of the wavefront at the input surface. The compressed spatiotemporal representation of the wavefront is then propagated through the homogeneous medium to the exit surface of the optical element, with each of the input x-vectors propagated into all of the corresponding x-vector's positions on the exit surface preferably using the dyadic Green's function propagator of equation 3. Similarly, each of the input y-vectors is propagated into all of the corresponding y-vector positions on the exit surface, preferably using the dyadic Green's function propagator of equation 3. This provides N sets of propagated x,y vector pairs on the exit surface of the optical element. The wavefront at the exit surface then can be recreated by taking the outer product between each of the pairs of vectors and summing the results of those individual outer products. As desired, the other frequency components could also be added. This provides an uncompressed estimate of the waveform at the exit surface of the optical element; that is, the sum of the monochromatic outer products is the complete spatiotemporal representation of the wavefront at that position.

This exit surface spatiotemporal representation of the waveform produced by this propagation could then be taken as the input wavefront representation for a next propagation through a next optical element. More preferably though, the next propagation does not recombine the monochromatic elements of the pulse and does not use the uncompressed wavefront. Instead, the preferred propagation strategy uses the monochromatic compressed N sets of propagated x,y vector pairs determined at the output of the most recent optical element as the input to the next optical element. So long as the optical elements are linear in nature, the compressed N vector set is used throughout the propagations to model the entire optical system of interest. The full, decompressed wavefront need only be generated when it is of interest to the user or when a different, nonlinear form of modeling is applied.

The grid discussed above for modeling the wavefront is stated as a uniform grid of x,y points. Other grid arrangements might be used instead.

In the above and other discussions here the process of taking an SVD and selecting N vector pairs and N weights are described as separate steps. This configuration is used for clarity on the discussion. It is well known that an SVD may be taken in such a manner that the SVD returns only the selected number N of vector sets and corresponding weights. This is sometimes called a “truncated SVD,” although the usage is inconsistent. Regardless, the process of taking an SVD and selecting vectors can take distinct steps or be an apparent single step in the context of these preferred embodiments. Another matter of nomenclature involves “principal component analysis” (PCA). Sometimes the term PCA is used interchangeably with SVD. In practice, PCA is generally considered a specific form of SVD.

In this way, the FIG. 1 apparatus can measure the spatiotemporal representation of an ultrafast laser pulse at a convenient point in an optical system and then that spatiotemporal representation can be propagated through the elements of the optical system to another position within the optical system of interest to the user or the analysis of the ultrafast laser pulse. An appropriate sampling position preferably is selected by case of accessing the beam and also by the nature of the beam at the proposed sampling position. Due to the resolution limitations of the Shack-Hartmann sensor, it is generally less desirable to sample the beam at a focus position and comparatively more desirable to sample where the beam is laterally spread and at least somewhat collimated. For convenience to the preferred additional propagation procedure, the sampling position preferably is at, or can be defined to be at, a surface of an optical element.

What follows is an overview of the propagation procedure. The optical system to be modeled or subjected to propagation is described in a configuration file, with each optical element described in sufficient detail for dyadic Green's function propagation as well as the relationships between the optical elements (i.e., common optical axes, separation, etc.). The optical elements include whatever free space separations exists within the optical path of the system. A variety of optical elements can be analyzed using the preferred dyadic Green's function approach. Generally appropriate optical elements include linear elements such as lenses but generally do not include amplifiers. Optical elements preferably have defined entrance and exit surfaces, uniform optical properties such as index of refraction, and defined thicknesses between the entrance and exit surfaces. Appropriate optical elements have generally well-behaved surfaces, with each surface preferably capable of being described by a single outer product.

The propagation strategies described here can be used in conjunction with other modeling strategies. For example, the dyadic Green's function propagation can be used to describe the field up to a fiber interface. Another strategy can be used to model the field propagation through the fiber, which is often nonlinear for ultrashort pulses. Similarly, dyadic Green's function propagation can be used to determine the spatiotemporal representation provided to an amplifier, such as a titanium-sapphire amplifier, and other modeling strategies can be used to establish how the amplification alters the input pulse characteristics. Measurements have also confirmed the accuracy of this combined modeling strategy.

The procedure identifies a starting point for the propagation based on where within the optical system the complete spatiotemporal representation is available. This might be a sampling point for the FIG. 1 apparatus or another measurement strategy or might be a theoretical wavefront representation. Using such a theoretical representation might be advantageous if the propagation is used in the design or verification of an optical system, particularly one for use with broadband sources. Typically a measured or other spatiotemporal representation of a wavefront is an array of discrete values at discrete positions for a digital representation. If the spatiotemporal representation is not discrete or if, more probably, the grid spacing is not well suited for propagation, the system converts the spatiotemporal representation into a desired grid spacing; the grid spacing is generally on the order of but less than the wavelength of the pulse. When the representation has an undesirable grid spacing, the wavefront representation can be adjusted using interpolation.

With the representation at a suitable grid spacing, the pulse is decomposed into chromatic components, for example using Fourier analysis, which have a limited wavelength range so that they can be considered monochromatic. For spatiotemporal representations generated by the FIG. 1 or a similar apparatus, the wavefront data may already be separated (or readily separable) by frequency and so preferably are available for processing as monochromatic components. Each of the chromatic components is propagated separately, as desired, and can be recombined to finalize propagation of a complete pulse when it is desirable to do so.

Preferably then the system evaluates the size of the monochromatic wavefront spatiotemporal data set and determines if the propagation is practical using the complete data set. As noted above, propagation may be practical for a limited size object such as a fiber optic waveguide, but propagation is often not practical due to the large number of points that must be propagated into each corresponding point. When the number of points in the spatiotemporal representation is large, such as when the system includes macroscopic optical elements, the system preferably compresses the spatiotemporal representation. One appropriate compression strategy is the singular value decomposition, discussed above, which is a known linear algebra function that factors a matrix into a multiplication of three matrices with desirable properties. The compression is performed by selecting the N largest weights of the singular value decomposition and using the resulting representation as an estimate of the spatiotemporal representation. When the compressed representation is used for propagation, the vectors corresponding to the selected N largest weights are propagated through the optical elements that make up the optical system.

Each vector of the representation corresponds to a set of points defined on the entrance surface to the optical element and another set of points defined on the exit surface of the optical element. The system analyzes the optical element to be propagated to determine whether the element thickness corresponds to the reactive or radiative near fields or the radiative far field to determine whether an approximation of the dyadic Green's function of equation 3 should be used or if the full equation 3 statement should be used. The system then propagates each position of the component representation vectors into each position of the corresponding vector on the exit surface of the optical element. Preferably, further propagation proceeds using the same vector representation, with the exit surface vectors becoming the entrance surface vectors for the next optical element and a new set of corresponding vectors positioned on the exit surface of the next optical element. The system preferably propagates the wavefront through the selected vector representation using the appropriate form of the equation 3 dyadic Green's function. Propagation continues until the system reaches the desired analysis position within the optical system, with propagation performed independently for each of the chromatic components of the pulse. At that point, the system preferably performs the outer product multiplications to decompress the data and those outer products are summed to retrieve the monochromatic spatiotemporal representations of the pulse. The various monochromatic components may also be added to provide the complete spatiotemporal representation of the pulse.

A specific example of wavefront propagation begins with a collimated ultrafast laser beam, which is then focused to the face of a fiber optic to couple some portion of the beam into the fiber. The coupled portion of the beam propagates through the fiber, exits the fiber, is collimated, and the beam then propagates through free space after collimation. The beam was kept at low power to avoid nonlinear effects in the fiber optic. To evaluate this optical system, the collimated ultrafast laser beam was measured by the FIG. 1 system prior to the focusing optic and was measured again by the FIG. 1 system after exiting the fiber and being collimated. The measurement prior to the focusing optic was input to the dyadic Green's function propagator, which propagated the laser beam through the focusing optic to the focus at the entrance to the fiber optic. At the entrance of the fiber optic, use of the dyadic Green's function propagator was inappropriate. Instead, to determine the beam coupling into the fiber, the analysis used an overlap integral between the spatiotemporal representation at the fiber with the mode field diameter of the fiber. The dyadic Green's function propagator then propagated the coupled beam within the fiber, through the exit of the fiber, to a collimating mirror, and from the collimating mirror to the second measurement position. The measured coupling efficiency as a function of wavelength was determined from the measured data and compared to similar values determined from the dyadic Green's function/overlap integral propagator.

FIG. 3 shows, for the ultrafast laser pulse coupling into an optical fiber, a comparison of the measured and propagated transmission through the fiber as a function of wavelength. The agreement is very good, particularly in showing the wavelength dependence of the coupling. There is a slight etalon effect (ringing) in the measured data that might be due to reflections within the focusing lens.

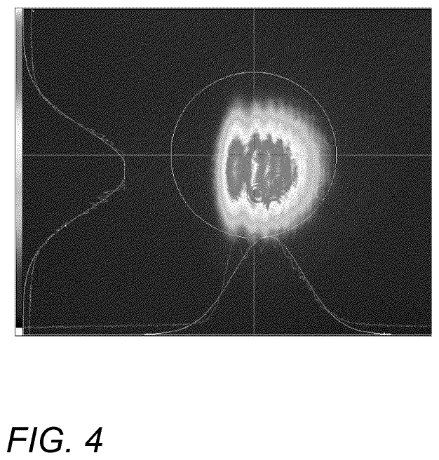

Another example is specifically directed to evaluating diffraction effects. In this case, an ultrafast laser beam is incident on a hard edge. The experimental arrangement is similar. The spatiotemporal representation is measured for a generally collimated beam prior to striking a hard edge that blocks half of the beam. The FIG. 1 apparatus makes a second spatiotemporal measurement approximately 30 cm past the hard edge to provide an experimental baseline. To evaluate the propagator, the spatiotemporal representation prior to the hard edge interaction is digitally clipped in half. This is a convenient way to introduce the hard edge to the spatiotemporal representation of the ultrafast pulse. Following the clipping, the dyadic Green's function propagator, using SVD compression, propagated the clipped beam for a distance of 30 cm through free space past the hard edge. The system determined the wavefront intensity for each of the wavelength components of the representation and added those component intensities together. The results are illustrated in FIG. 4, which is very similar to the intensity pattern measured in the second FIG. 1 spatiotemporal measurement. The FIG. 4 mapping clearly shows banding of the type that would be expected from diffraction at a hard edge (which is indeed seen in the spatiotemporal measurement, not shown here).

The ultrafast laser applications discussed here present illustrate a particular type of broadband light source. Just as the above propagation strategies are particularly beneficial for the ultrafast pulse as an example of the output of a broadband source, these propagation strategies can be applied to other broadband light sources. The propagation strategies might be used in the testing, evaluation, and design of optical systems for broadband light. For the testing, evaluation, and design of optical systems for broadband light, it is often practically sufficient to test, evaluate, or design the sustem using two or three specific wavelengths. As discussed above, the preferred compressed dyadic Green's function propagator separately propagates individual wavelengths within the system and then, as desired, the system may recombine the various wavelengths into the full propagated pulse. When used in the testing, evaluation, and design of optical systems, the system described here may desirably not combine all wavelengths and instead may not combine the results of individual wavelength propagations or may only combine two or three propagated wavelengths to evaluate the system. It may be desirable to contrast the propagated wavefront information for two wavelengths to highlight wavelength dependencies.

Although the invention has been described in detail with particular reference to these preferred embodiments, other embodiments can achieve the same results. Variations and modifications of the present invention will be apparent to those skilled in the art. The present invention is not defined by the various embodiments described here but is instead defined by the claims, which follow.

1. A method of propagating a spatiotemporal representation of a broadband pulse through an optical system, comprising:
measuring a spatiotemporal representation of a broadband pulse to provide a first wavefront data set;
compressing the first wavefront data set into a set of first compressed vectors; and
propagating the set of first compressed vectors through a first optical element to generate a set of second compressed vectors representative of the broadband pulse passing through the first optical element.

2. The method of claim 1, wherein the propagating is performed using a dyadic Green's function propagator corresponding to a monochromatic solution of a Helmholz equation for a homogeneous medium.

3. The method of claim 1, wherein the compressing is performed using singular value decomposition and selecting N vectors from the results of the singular value decomposition.

4. The method of claim 3, wherein the selecting is based on values of weights associated with the N vectors.

5. The method of claim 4, wherein the selecting is further based on a target level of accuracy in the propagated spatiotemporal representation.

6. The method of claim 1, wherein the measuring comprises:
performing a spatially and wavelength resolved wavefront measurement; and
performing a temporal measurement.

7. The method of claim 6, wherein the temporal measurement is performed using a self-referencing measurement.

8. The method of claim 6, wherein entrance positions to the spatially and wavelength resolved wavefront measurement and to the temporal measurement are defined by a set of apertures in a template.

9. The method of claim 6, wherein the spatially and wavelength resolved wavefront measurement iteratively scans a slit with respect to an input ultrafast laser pulse to select spectral slices from the pulse.

10. The method of claim 1, wherein the broadband pulse comprises one or more wavelengths.

11. The method of claim 10, wherein the first wavefront data set represents one wavelength.

12. A method of propagating a spatiotemporal representation of a broadband pulse through an optical system, comprising:
receiving a spatiotemporal representation of a broadband pulse including a first wavefront data set;
compressing the first wavefront data set into a set of first compressed vectors; and
propagating the set of first compressed vectors through a first optical element to generate a set of second compressed vectors representative of the broadband pulse passing through the first optical element.

13. The method of claim 12, wherein the propagating is performed using a dyadic Green's function propagator corresponding to a solution of a Helmholz equation for a homogeneous medium.

14. The method of claim 12, wherein the compressing the first wavefront data set comprises:
performing a singular value decomposition on the first wavefront data set; and
selecting N sets of vectors from the singular value decomposition to be the set of first compressed vectors.

15. The method of claim 14, further comprising propagating the set of second compressed vectors through a second optical element to generate a set of third compressed vectors representative of the ultrafast laser pulse passing through the second optical element.

16. The method of claim 14, wherein the selecting N sets of vectors is based on values of weights associated with the N sets of vectors.

17. The method of claim 16, wherein the selecting N sets of vectors is further based on a target level of accuracy in the propagated spatiotemporal representation.

18. The method of claim 12, wherein the broadband pulse comprises one or more wavelengths.

19. The method of claim 18, wherein the first wavefront data set represents a single wavelength.

20. A method for characterizing a broadband pulse within an optical system comprising:
sampling a broadband pulse from within an optical system to extract a set of first slices from the broadband pulse;
for each of the set of first slices, measuring a wavefront of the broadband pulse using a spatially and spectrally resolved first wavefront detector to produce a first signal set;
sampling the broadband pulse to extract at least one second slice from the broadband pulse, the second slice oriented differently from the first slices;
for the at least one second slice, measuring a wavefront of the broadband pulse using a spatially and spectrally resolved second wavefront detector to produce a second signal set;
sampling the broadband pulse to extract an optical signal from a central portion of the broadband pulse and performing measurements to produce a spectrally and temporally resolved third signal set;
processing the first, second, and third signal sets to provide a measured spatiotemporal representation of the broadband pulse; and
propagating the measured spatiotemporal representation to a second position within the optical system to provide a propagated spatiotemporal representation at the second position.

21. The method of claim 20, wherein the propagating comprises:
compressing the measured spatiotemporal representation into a set of first compressed vectors; and
propagating the set of first compressed vectors through a first optical element to generate a set of second compressed vectors representative of the broadband pulse after passing through the first optical element.

22. The method of claim 21, wherein the propagating the set of first compressed vectors uses a dyadic Green's function propagator.

23. The method of claim 22, wherein the first optical element is homogeneous and the set of first compressed vectors represents a monochromatic field.

24. The method of claim 21, wherein the compressing is performed using singular value decomposition and selecting N vectors from the results of the singular value decomposition.

25. The method of claim 24, wherein the selecting is based on values of weights associated with the N vectors.

26. The method of claim 25, wherein the selecting is further based on a target level of accuracy in the propagated spatiotemporal representation.

27. The method of claim 20, wherein the first wavefront detector comprises a first two-dimensional detector array within an imaging spectrometer.

28. The method of claim 27, wherein the first wavefront detector comprises a Shack-Hartmann sensor.

29. The method of claim 20, wherein the second wavefront detector comprises a Shack-Hartmann sensor.
